(19) United States
(12) Patent Application Publication
(10) Pub. No.: US 2006/0173802 A1
(43) Pub. Date: Aug. 3, 2006

(54) Method for extraction of pertinent information taking into account the objective and the target

(75) Inventors: Miniar Hemaissia, Paris (FR); Juliette Mattioli, Paris (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: THALES, Neuilly Sur Seine (FR)

(21) Appl. No.: 10/564,528

(22) PCT Filed: Jul. 12, 2004
(86) PCT No.: PCT/EP04/51456

§ 371 Date: Jan. 13, 2006

(30) Foreign Application Priority Data
Jul. 15, 2003 (FR) 0308620

(51) Int. Cl. G06F 17/30

(52) U.S. Cl. 707/1

(57) ABSTRACT

The method in accordance with the invention is a method of extracting pertinent information taking into account the objective and the target, and it is wherein the target and the objective are identified, that the values applicable to the target are determined and that they are weighted according to their importance in relation to the target, that each of the information items of the information base is successively examined, that the preferences or degrees of importance of each of these information items are evaluated according to at least one criterion dependent on the target, that each information item is weighted by allocating to it at least one value, that, on the basis of the values thus weighted, a morphological filter, dependent on the objective and on the target, is applied to the values associated with the information of the base, that thereafter an identification of the pertinent elements of the base is effected so as to match the filtered values up with the elements of the base and that these pertinent elements are extracted.

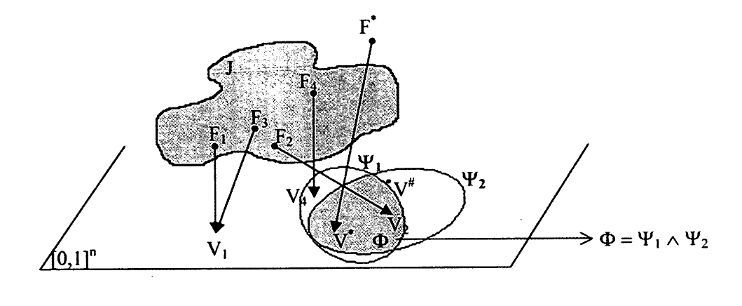

### BACKGROUND OF THE INVENTION

1) Field of the Invention

The present invention pertains to a method of extracting pertinent information taking into account the objective and the target.

2) Description of Related Art

The method of the invention applies in different contexts where a decision maker:
has available a base of information which is or can be evaluated with regard to a certain number of criteria;
seeks to satisfy or to convince a given target, for which target the importance or the pertinence of the criteria is known or can be obtained;
possesses an objective which is specific to him and which is or can be evaluated according to these same criteria.

This is the case when, for example, a decision maker has to formulate a convincing line of argument to arrive at a given conclusion, while persuading a target, that is to say that the arguments used have to enable him to reach the desired conclusion, having the agreement of the audience (at least of the majority of this audience). This context corresponds to the field of “propaganda”: advertising, marketing, politics, etc.

In this type of context, the decision maker has available an information base which is a set of facts or of events; the target is a given audience, composed of one or more people; the objective corresponds to the conclusion which the decision maker wishes to arrive at by extracting pertinent facts or events from the database enabling him to construct a convincing line of argument, and the criteria used for the extraction are the values of the audience, that is to say the elements, for example psychological, which characterize at least the majority of the audience.

There is currently no automated method making it possible to carry out such an extraction of information while taking account at one and the same time of the objective and of the target.

### SUMMARY OF THE INVENTION

One object of the present invention is a method of extracting, from an information base, facts or events which are pertinent in relation to a target and which simultaneously make it possible to attain the fixed objective.

The method in accordance with the invention is a method of extracting pertinent information from an information base taking into account the objective and the target and it is characterized in that the target and the objective are identified, that the values applicable to the target are determined and that they are weighted according to their importance in relation to the target, that each of the information items of the information base is successively examined, that the preferences or degrees of importance of each of these information items are evaluated according to at least one criterion dependent on the target, that each information item is weighted by allocating to it at least one value, that on the basis of the values thus weighted, a morphological filter, dependent on the objective and on the target, is applied to the values associated with the information of the base, that thereafter an identification of the pertinent elements of the base is effected so as to match the filtered values up with the elements of the base and that these pertinent elements are extracted.

The invention is implemented, for example, as specified hereinabove, so as to construct a line of argument enabling a decision maker to arrive at the desired conclusion (convince an audience to vote for him, for example) while taking account of the values of the audience (the electoral topics which have the most importance for the majority of the audience), the result of this being to obtain some agreement of this audience (recognize that the plan of action presented by the candidate does indeed comply with all the important topics), or at the very least of the majority of this audience.

### BRIEF DESCRIPTION OF THE DRAWING

The present invention will be better understood on reading the detailed description of an embodiment, taken by way of non-limiting example and illustrated by the appended drawing, in which:
the single FIGURE is a diagram illustrating the use of operators in accordance with the method of the invention.

### DETAILED DESCRIPTION OF THE INVENTION

The method of the invention will be described with reference to the case of the taking of a decision relating to a group of people, but it is of course understood that the invention is not limited to this application alone, and that it may be implemented in all cases where one wishes to extract pertinent information from a digitized or digitizable information base, regardless of the volume thereof, with a view to constructing a line of argument, a reasoning, a plan of action, etc.

The present example pertains to the case where the decision that a decision maker has to take is the selection of an alternative (one of the terms of a choice) while taking account of a number of items of information and while satisfying practically all the people who are involved or affected by the decision process. In this group decision context (also referred to as “collaborative”), the information base is composed of all the available data relating to resources (hardware, people, time, etc), alternatives, etc. The target corresponds to the people who are involved or affected by the decision process. The objective corresponds to the alternative desired by the decision maker. The criteria are the values to be taken into account so as to satisfy the target.

The method of the invention makes it possible to extract the pertinent information and/or the alternatives which would enable the decision maker to take his decision in full knowledge of the facts and whilst satisfying all parties (or the majority of them).

A main step of the invention is to construct a filter which selects a set of facts that are pertinent in regard to an objective to be attained while complying with a given target. Thus, the process of the invention has the following elements as input:
a base of information, each item of which can be evaluated with regard to a certain number of criteria;
a given target, for which it is possible to evaluate the importance of the information according to the criteria used;
an objective which can also be evaluated according to these same criteria.

This filter must possess the following properties:
If the filter is applied to an information base, BI, which contains a given set of information, BF, then the elements selected from this set BF will also be selected for the base BI.
The result of the filter is necessarily contained in the initial base.
Re-applying the filter serves no purpose, but it may be modified.

The present invention implements filters of morphological opening type, arising from the technology of mathematical morphology, which possess, by construction, these properties. In this regard, reference may be made to the book entitled “Morphologie mathematique” by M. SCHMITT and J. MATTIOLI published in 1994 by Editions MASSON.

The method of the invention implements such filters and comprises the following three main steps:
1. For each item of information of the base BI, we evaluate, in a numerical manner, the preferences or degrees of importance according to target—dependent criteria. A set of values is then allocated to each information item. These values are obtained by semi-automatic analysis (for example with the aid of the “MACBETH” software), by an operator, an expert, etc. Thus, for each element of the base BI, the associated weighted values are obtained.
2. A morphological filter dependent on the objective and on the target is applied to the values associated with the elements of the base BI. This filter may be, in a manner known per se, a distance or a metric, for example.
3. An identification of the elements of the base BI is made in such a way as to match the filtered values up with the elements of BI.

Thus, at the end of step 3, the whole set of information is obtained taking account of the objective and of the target, rendering the information pertinent. As appropriate, the pertinent information thus obtained is ranked by order of pertinence. Finally, a line of argument can be constructed from this information.

In the following account, we recall the definitions of the terms used during the implementation of the morphological filters and their essential properties.

Let ℑ be the base of facts, that is to say: ℑ={F|F identified fact}.

Let F* be the objective to be attained. We assume that F*∉ℑ, otherwise the solution of the problem is immediate.

Let Val be the valuation function ℑ→[0,1]ⁿ where n is the number of values such that Val(F)=(v₁, . . . , vₙ) where vᵢ represents the degree of importance of the i^{th} value corresponding to the fact F.

We write V^{#}=(v₁^{#}, . . . , vₙ^{#}), the estimated value of the target and V*=Val(F*), the calculated value of the objective to be attained.

The aim here is to construct a filter which selects from ℑ the facts which are pertinent in regard to the objective to be attained F* while complying with the target.

We firstly recall the following properties:
(1) ∀X⊂Y, Ψ(X)⊂Ψ(Y), which corresponds to monotonicity. This implies that if Ψ is applied to a base Y which contains X, then the elements selected from X will also be selected for Y.
(2) ∀X, Ψ(X)⊂X, which corresponds to anti-extensivity. This implies that the result of Ψ is necessarily contained in the initial base.
(3) ∀X, Ψ∘Ψ(X)=Ψ(X), which corresponds to idempotency. This implies that re-applying the operator Ψ serves no purpose.

If Ψ possesses properties (1) and (3), it is mathematically a filter and if, moreover, Ψ satisfies (2), we then speak of morphological opening. Having regard to the objective of the invention, the operator to be constructed is necessarily a morphological filter.

The invention proposes the application of an operator to ℑ which makes it possible to satisfy (1), (2) and (3). To do this, we construct two operators on Im(Val)={V|∃Fεℑ,V=Val(F)}, which is the set of values associated with the base of facts ℑ.

It will be noted that the function Val is a mapping (to each fact, a corresponding value can be calculated), but not necessarily bijective. It may happen that—for a given value, there exist two distinct facts which correspond to it.

We shall construct two filters on Im(Val), which are operators as defined hereinabove.

Let Ψ₁ be the filter defined by Ψ₁(Im(Val))={VεIm(Val)|d(V,V*)≦d(V*,V^{#})}. Ψ₁,(Im(Val)) is therefore the subset of the values of distance to v* less than or equal to the constant d(V*,V^{#}), where d is a distance, for example of the form d(x,y)=supᵢ|xᵢ−yᵢ| for a fine filter (strongly filtering), or

$$d ( x \text{,} y ) = {\sum }_{i} \vert {x}_{i} - {y}_{i} \vert$$

for a coarse filter (weakly filtering), x and y being the values considered for these distances (V*,V^{#}, . . . ).

It follows that Ψ₁ is a morphological opening.

Let Ψ₂ be the filter defined by Ψ₁(Im(Val))={VεIm(Val)|d(V,V^{#})≦d(V*,V^{#})}.

Let Φ=Ψ₁ [symbol] Ψ₂, that is to say: Φ(Im(Val))=Ψ₁(Im(Val))∩Ψ₂(Im(Val)).

This has been represented in the single FIGURE of the drawing. In the base of facts ℑ, we have represented four facts F₁ to F₄. The facts F₁ and F₄ having in this example the same weights, the same value V₁ corresponds to them. The facts F₂ and F₄ have different weights, and the values V₂ and V₄ respectively correspond to them. We denote by F* the objective to be attained. Of course, as specified hereinabove, this objective does not belong to the base of facts, and it has therefore been represented outside of this base of facts. We have also represented the filters Ψ₁ (taking account of the objective) and Ψ₂ (taking account of the target), the intersection Φ of which is hatched. To the objective F* there corresponds the value V* which is the calculated value of the objective to be attained and which is situated in said intersection.

We note that if Ψ₁ and Ψ₂ are morphological openings, then Ψ₁ [symbol] T₂ is also an opening.

We write Val⁻¹ for the inverse function which is defined by: Val⁻¹(V)={Fεℑ|Val(F)=V}. The filter Ω on the base of facts is then defined by the following diagram:

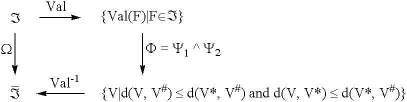

In this diagram, the valuation function Val makes it possible to obtain the value of the fact F (which fact is part of the base of facts ℑ) for each fact of the base. After filtering by Φ, we obtain the degree of importance v corresponding to the fact F, and by applying the inverse function Val⁻¹, we obtain the filtered base of facts \overline{ℑ}. By construction we clearly have \overline{ℑ}⊂; as Φ is idempotent, we have for Ω the operator which makes it possible to filter the base ℑto obtain \overline{ℑ}:
Ω∘Ω=(Val⁻¹∘Φ∘Val)∘(Val⁻¹∘Φ∘Val)
=Val⁻¹∘Φ∘(Val∘Val⁻¹)∘Φ∘Val
=Val⁻¹∘(Φ∘Φ)∘Val
=Val⁻¹∘Φ∘Val
=Ω

Ω is therefore idempotent and relation (1), monotonicity, is true by construction.

The implementation of the method of the invention will be illustrated with the aid of a very simplified example.

According to this example, we need to construct a line of argument on the basis of the following data:
the target audience is a fictitious population class B,
the objective consists in convincing the audience of class B that the fictitious class A of individuals is seeking confrontation with class A,

the values of the audience are the universal Schwartz values, well known in the field of psychology. These values are weighted as a function of the importance that class B may accord to them. Each weight is a value vᵢ from the interval [0, 1]. The ten values V1 to V10 considered in the present example have the following weights respectively:

| | |
|---|---|
| Power | 0.9 |
| Achievement | 0.5 |
| Hedonism | 0.95 |
| Stimulation | 0.6 |
| Self-direction | 0.9 |
| Benevolence | 0.4 |
| Tradition | 0.1 |
| Conformity | 0.2 |
| Security | 0.75 |
| Universalism | 0.45 |

The information base consists of the following eight facts (F1 to F8), such as gleaned successively from a series of press releases, and which are weighted as charted in the table below:
F1: the American Congress authorizes President Bush to resort to force against Iraq
F2: thirteen attacks have been perpetrated in Corsica
F3: a member of class A has beaten to death a member of class B
F5: a Tchetchnian commando unit is holding 700 people hostage in Moscow
F6: class B has voted for the resumption of negotiations
F7: a strike notice has been issued by the employees of the Post Office
F8: the representative of class B has won prize XYZ
The weighting of the objective is as follows, for the same values V1 to V10: {0.5 0 0 0 0 0 0 0 1 0}

Thus, after morphological filtering, the method of the invention retains the following five facts:
F1: the American Congress authorizes President Bush to resort to force against Iraq
F2: thirteen attacks have been perpetrated in Corsica
F3: a member of class A has beaten to death a member of class B
F5: a Tchetchnian commando unit is holding 700 people hostage in Moscow
F6: class B has voted for the resumption of negotiations

The line of argument produced with the aid of these filtered facts is: “although class B has voted for the resumption of negotiations, a member of class A has beaten to death a member of class B, but murder constitutes confrontation, hence class A is seeking confrontation”.

Table of weighting of the facts F1 to F8

| | | WEIGHT | | | | | | | | | |
|---|---|---|---|---|---|---|---|---|---|---|---|
| | | VALUE | | | | | | | | | |
| | | V1 | V2 | V3 | V4 | V5 | V6 | V7 | V8 | V9 | V10 |
| FACTS | F1 | 0.8 | 0.3 | 0 | 0 | 0.3 | 0.5 | 0.1 | 0 | 0.8 | 0.5 |
| | F2 | 0.5 | 0 | 0 | 0 | 0 | 0.2 | 0.2 | 0 | 0.9 | 0.2 |
| | F3 | 0.5 | 0 | 0 | 0.2 | 0 | 0.5 | 0 | 0 | 0.9 | 0.5 |
| | F4 | 0.9 | 0 | 0 | 0 | 0 | 0 | 0 | 0 | 0 | 0 |
| | F5 | 0.9 | 0 | 0 | 0 | 0.5 | 0.3 | 0.3 | 0.3 | 0.9 | 0.6 |
| | F6 | 0.5 | 0 | 0 | 0 | 0 | 0.8 | 0 | 0 | 0.8 | 0.8 |
| | F7 | 0.6 | 0.5 | 0 | 0 | 0.5 | 0.6 | 0 | 0 | 0 | 0.3 |
| | F8 | 0.9 | 0.9 | 0.8 | 0.8 | 0.6 | 0 | 0 | 0 | 0 | 0 |

1. A method of extracting pertinent information from an information base taking into account the objective and the target, comprising the steps of:
acquiring information base is, identifying the target and the objective, determining values applicable to the target weighting values according to their importance in relation to the target, that each of the information items of the information base is successively examined, evaluating preferences or degrees of importance of each of these information items according to at least one criterion dependent on the target, such that each information item is weighted by allocating to it at least one value, that, on the basis of the values thus weighted, a morphological filter, dependent on the objective and on the target, is applied to the values associated with the information of the base, and thereafter an identification of the pertinent elements of the base is effected so as to match the filtered values up with the elements of the base and that these pertinent elements are extracted.

2. The method as claimed in claim 1, wherein the filter is a distance or a metric.

3. The method as claimed in claim 1, wherein the evaluation of the preferences or degrees of importance is effected in a numerical manner.

4. The method as claimed in claim 3, wherein the values allocated to each information item are obtained by semi-automatic analysis, by an operator or by an expert.

5. The method as claimed in claim 1, wherein the pertinent elements are ranked by order of pertinence.

6. The method as claimed in claim 2, wherein the evaluation of the preferences or degrees of importance is effected in a numerical manner.

7. The method as claimed in claim 3, wherein the values allocated to each information item are obtained by semi-automatic analysis, by an operator or by an expert.

8. The method as claimed in claim 2, wherein the pertinent elements are ranked by order of pertinence.

9. The method as claimed in claim 3, wherein the pertinent elements are ranked by order of pertinence.

10. The method as claimed in claim 4, wherein the pertinent elements are ranked by order of pertinence.
